(19) United States
(12) Patent Application Publication
(10) Pub. No.: US 2018/0101529 A1
(43) Pub. Date: Apr. 12, 2018

(54) DATA SCIENCE VERSIONING AND INTELLIGENCE SYSTEMS AND METHODS

(71) Applicant: Proekspert AS, Tallinn (EE)

(72) Inventors: Andre Karpistsenko, Tallinn (EE); Tanel Peet, Viljandi (EE); Martin Lumiste, Tallinn (EE); Taivo Pungas, Tallinn (EE); Andrus Kuus, Viimsi vald (EE); Aleksei Saenko, Tallinn (EE); Peeter Meos, Tallinn (EE)

(21) Appl. No.: 15/728,371

(22) Filed: Oct. 9, 2017

Related U.S. Application Data
(60) Provisional application No. 62/406,106, filed on Oct. 10, 2016.

(51) Int. Cl. G06F 17/30; G06F 17/50

(52) U.S. Cl. CPC G06F 17/3023; G06N 99/005; G06F 17/5009

(57) ABSTRACT

This disclosure relates to systems and methods for interacting with, controlling, and/or otherwise managing statistical, machine learning, data mining, and/or other predictive methods to produce algorithms for intelligent systems. Various embodiments allow for management of diverse, distributed predictive algorithms via user interfaces and APIs that enable access to configuration, optimization, and/or other activities related to managing computational models in training, production, and/or archival processes. Further embodiments disclosed herein allow for the tracking and/or improvement of models over time.

### RELATED APPLICATIONS

This application claims the benefit of priority under 35 U.S.C. § 119(e) to U.S. Provisional Patent Application No. 62/406,106, filed Oct. 10, 2016, and entitled “DATA SCIENCE INTELLIGENCE: METHODS FOR INTERACTING WITH PREDICTIVE ALGORITHMS,” which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to computer technology systems and methods. More specifically, but not exclusively, the present disclosure relates to systems and methods associated with information systems, data processing, data analytics, and data visualization.

### SUMMARY

Statistical, machine learning, data mining, and/or other predictive methods may be used to produce algorithms and/or models for intelligent systems. Over time, the number of models associated with statistical, machine learning, data mining and other predictive methods may grow, along with the desirability to monitor and optimize models in production. Conventional machine learning platforms may impose a rigid structure and process for creating and operating models. Embodiments of the systems and methods disclosed herein may provide for more flexible methods for creating models and interacting with models in operations and/or solutions for interactions with models in a real-time environment.

To mitigate model performance decay, address concept drift, outliers, and/or other external events such as marketing campaign induced increase in system usage activity, data scientists and engineers may continuously monitor, revise, and/or improve existing models. Embodiments of the systems and methods disclosed herein may provide a platform for engaging in such activities in a relatively automated manner.

In manufacturing, global Internet services, product delivery, and services for cyber physical systems, the number of models an organization may use can grow very large, from a few models to millions of models. Consistent with embodiments disclosed herein, automated dashboards, alerts and other solutions may be employed for tracking models and/or identifying models and/or algorithms that require attention. Various methods for interacting with such a platform and/or dashboard are disclosed herein.

In certain embodiments, a method of processing data consistent with embodiments disclosed herein may include receiving data from at least one data source. The data may be received as batch data and/or as a data stream. The data may be received from a variety of data sources including, for example, device information data sources, planetary information data sources, and/or manufacturing data sources.

The at least a first portion of the received data may be processed using a computational model based, at least in part, on a first set of one or more parameters, to generate first output data. The first set of one or more parameters may comprise one or more of a bounding parameter, a detection rate parameter, an update rate parameter, a sample size parameter, a data window parameter, a probing parameter, a process parameter, an environmental parameter, and/or any other suitable parameter.

In some embodiments, processing the at least a first portion of the received data using the computational model may include pre-processing the at least a first portion of the received data to generate first intermediate data based, at least in part, on a third set of one or more parameters. Processing the at least a first portion of the received data using the computational model may involve processing the first intermediate data using the computational model.

First computational model version information comprising a first set of execution events associated with generating the first output data using the computational model and the first set of one or more parameters may be generated and/or otherwise stored. In some embodiments, the first computational model version information may further include the third set of execution events associated with generating the first intermediate data and the third set of one or more parameters. In further embodiments, the first computational model version information may comprise information associated with the at least a first portion of the received data and/or information associated with the first output data. In yet further embodiments, the first computational model version information may comprise a unique version identifier associated with the first computational model version information (e.g., a branching version identifier), at least one script associated with the computational model, and/or an indication of a location of at least one script associated with the computational model.

In certain embodiments, a second set of one or more parameters may be generated. The second set of one or more parameters may be generated based on user and/or system specified parameters. In further embodiments, the second set of one or more parameters may be generated based, at least in part, on the first output data.

At least a second portion of the received data may be processed using the computational model based, at least in part, on the second set of one or more parameters, to generate second output data. In some embodiments, the first portion and the second portion of the received data may be the same. In further embodiments, the first portion and the second portion of the received data may different, at least in part.

In some embodiments, processing the at least a second portion of the received data may include updating the computational model based, at least in part, on the second set of one or more parameters, and processing the at least a second portion of the received data based, at least in part, on the updated computational model to generate the second output data. In further embodiments, processing the at least a second portion of the received data using the computational model may include pre-processing the at least a second portion of the received data to generate second intermediate data based, at least in part, on the third set of one or more parameters. Processing the at least a second portion of the received data using the computational model may involve processing the second intermediate data using the computational model. In yet further embodiments, processing the at least a second portion of the received data to generate the second output data further comprises processing at least a portion of the first output data to generate the second output data.

Second computational model version information comprising a second set of execution events associated with generating the second output data using the computational model and the second set of one or more parameters may be stored. In some embodiments, the second computational model version information may include an indication of a difference between at least one updated script associated with an updated computational model used to generate the second output data and at least one script associated with the computational model used to generate the first output data. In further embodiments, the second computational model version information may include an indication of a difference between the first set of one or more parameters and the second set of one or more parameters.

A request may be received from a requesting system for information associated with the computational model. A response may be generated based, at least in part, on the first computational model version information and the second computational model version information. In further embodiments, the response may be generated based on the first output data and/or the second output data. The response may be transmitted to the requesting system.

Embodiments of the aforementioned method may be performed, at least in part, by any suitable system and/or combination of the system and/or implemented using a non-transitory computer-readable medium storing associated executable instructions.

### BRIEF DESCRIPTION OF THE DRAWINGS

The inventive body of work will be readily understood by referring to the following detailed description in conjunction with the accompanying drawings, in which:

FIG. 1 illustrates an example of an architecture for interacting with data consistent with embodiments of the present disclosure.

FIG. 2 illustrates an example of a directed acyclic graph consistent with embodiments of the present disclosure.

FIG. 3 illustrates an example of execution event versioning consistent with embodiments of the present disclosure.

FIG. 4 illustrates an example of a dashboard for interacting with predictive models consistent with embodiments of the present disclosure.

FIG. 5 illustrates an example of an interface for outlier detection consistent with embodiments of the present disclosure.

FIG. 6 illustrates an example of an interface for numeric simulation visualization consistent with embodiments of the present disclosure.

FIG. 7 illustrates an example of an interface for interacting with a predictive model consistent with embodiments of the present disclosure.

FIG. 8 illustrates a flow chart of an exemplary method of interacting with data consistent with embodiments of the present disclosure.

FIG. 9 illustrates an exemplary system that may be used to implement various embodiments of the systems and methods of the present disclosure.

### DETAILED DESCRIPTION

A detailed description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, where in some instances, like parts may be designated by like numerals. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of any method disclosed herein do not necessarily need to be executed in any specific order, or even sequentially, nor need the steps be executed only once, unless otherwise specified.

Embodiments of the systems and methods disclosed herein may be utilized in connection with interacting with, controlling, and/or otherwise managing statistical, machine learning, data mining, and/or other predictive methods to produce algorithms for intelligent systems. In certain embodiments, the disclosed systems and methods may allow for flexibility in connection with creating, interacting with, and/or managing computational models to producing intelligent algorithms. Further embodiments disclosed herein allow for the tracking and/or improvement of models over time.

Data Science Ecosystem Overview

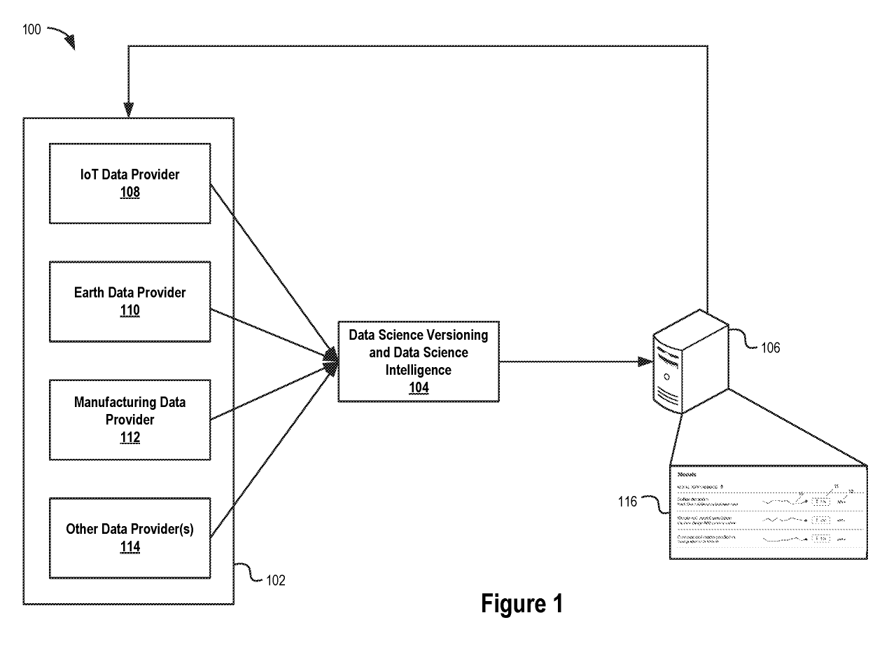

FIG. 1 illustrates an example of an architecture 100 for interacting with data consistent with embodiments of the present disclosure. As illustrated, the architecture 100 may comprise one or more data sources 102, predictive model(s) and/or data science versioning and/or intelligence layers 104, and/or one or more associated computer and/or control systems 106. Various aspects of the architecture 100 and/or its constituent elements 102-106 may comprise one or more computing devices that may be communicatively coupled via a network. The various elements 102-106 may comprise and/or otherwise be associated with a variety of computing devices and/or systems, including laptop computer systems, desktop computer systems, server computer systems, notebook computer systems, augmented reality devices, virtual reality devices, distributed computer systems, smartphones, tablet computers, and/or the like.

As discussed in more detail below, the various computing systems used in connection with the disclosed embodiments may comprise at least one processor system configured to execute instructions stored on an associated non-transitory computer-readable storage medium. The various elements 102-106 may further comprise software and/or hardware configured to enable electronic communication of information between associated devices and/or systems via a network and/or other communication channels using any suitable communication technology and/or standard.

Communication between various aspects of the architecture 100 may utilize a variety of communication standards, protocols, channels, links, and/or mediums capable of transmitting information via one or more networks. The network may comprise the Internet, a local area network, a virtual private network, a mobile network, and/or any other communication network utilizing one or more electronic communication technologies and/or standards (e.g., Ethernet or the like).

The one or more data sources 102 may comprise one or more data preprocessing subsystems, platforms, and/or service providers (e.g., data services providing one or more data streams). The data sources 102 may comprise a variety of device and/or system data sources and/or associated providers. For example, the data sources 102 may comprise one or more internet-of-things (“IoT”) device and/or system data providers 108, planetary, earth and/or geospatial data providers 110, manufacturing service data providers 112, and/or other data providers 114 providing a variety of data that may be used in connection with various aspects of the disclosed embodiments. It will be appreciated that a variety of types of data and/or associated data sources 102 and/or providers may be used in connection with aspects of the disclosed embodiments, and that any suitable type of data and/or data source may be used in connection with the systems and methods disclosed herein.

The predictive model and/or data science versioning and/or intelligence layer 104 may comprise one or more predictive model subsystems configured to implement various aspects of the disclosed embodiments. The predictive model subsystems may, for example, implement various tools for creating predictions and meaningful analytics relating to data provided by the one or more data sources 102. The architecture 100 may further comprise one or more computer and/or control systems 106 configured to implement various aspects of the disclosed embodiments including, in some embodiments, various functionalities associated with the predictive model and/or data science versioning and/or intelligence layer 104. For example, the one or more computer and/or control systems 106 may allow a user to interact with predictive models via a dashboard 116 consistent with embodiments of the present disclosure. In some embodiments, the one or more computer and/or control systems 106 may be configured to facilitate real-time interaction with various predictive models.

Various elements 102-106 of the architecture may implement a variety of data preprocessing techniques including, without limitation, visualization preprocessing. Visualization preprocessing may be performed in various steps of the data pipeline. For example, in some embodiments, data processing and association with data sources may be performed by a server using native connections and stream processing libraries. In some embodiments, data filtering, transformation, and/or aggregation may be performed by a server and the processes may pipe streams through a key-value store.

Data exchange between services and clients in the architecture 100 may be performed by pushing data via web sockets or synchronization wrappers (e.g., Deepstream, Feathers, PouchDb, etc.). In some embodiments client-side filtering, transforming, and/or aggregation may be performed using higher order reactive streams (e.g., Highland, Kefir, XStream, etc.) and/or light client-side databases (e.g., Level.js, PouchDB, etc.). Visualization scaling, shape generation, and/or data interaction consistent with embodiments disclosed herein may utilize, for example, SVG, WebGL, AScatterplotAnime, and/or the like. For example, using WebGL, the visualizations may be performed using server-side processing that, in certain embodiments, may be implemented using QT with a WebGL plugin compiled using Emscripten to exchange user interfaces using low level remote procedure calls. In further embodiments, DOM nodes in the UI threads may be implemented using throttling control on the server side allowing pausing and resuming streams among other features.

In certain embodiments, for larger data volumes and update rates, visualisations may be improved using synchronization of updates with background web worker and performance.now( ) synchronization of updates using WebAudio for constant update cycles and other solutions (e.g., solutions based on Firespray). In some embodiments, the visualization values may be made visible to a user via a dashboard 116 (e.g., through pointer hover and click and/or another suitable user interaction). In some embodiments, the visualizations may have media controls for real-time content allowing playback, rewind, fast forward, and/or adjusting a sliding window of certain events.

It will be appreciated that a number of variations can be made to the architecture and relationships presented in connection with FIG. 1 within the scope of the inventive body of work. For example, certain aspects and/or functionalities of the architecture 100 described above may be integrated into a single system and/or any suitable combination of systems in any suitable configuration. Thus, it will be appreciated that the architecture of FIG. 1 is provided for purposes of illustration and explanation, and not limitation.

Directed Acyclic Graph of Data Processing

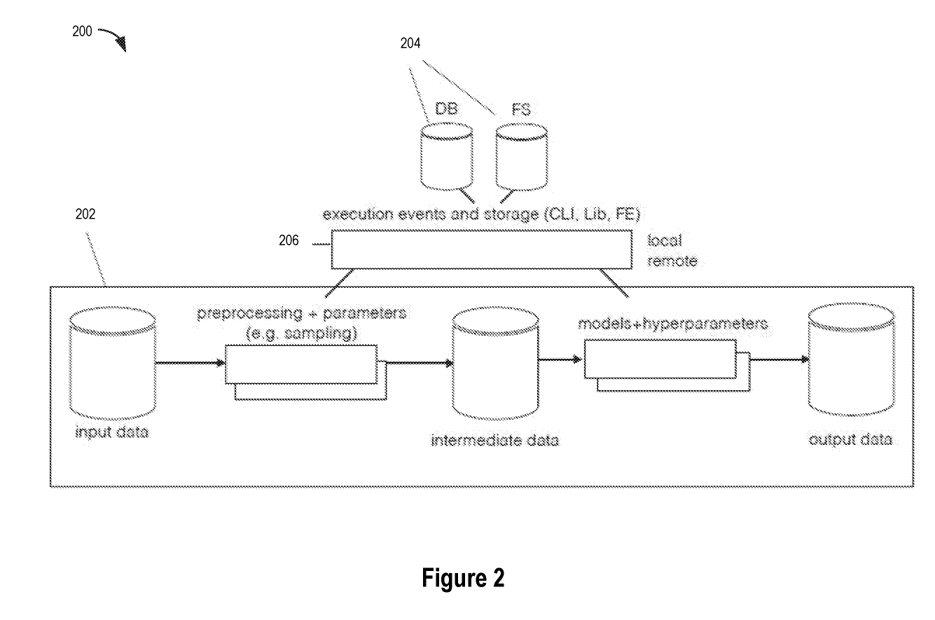

Predictive and/or intelligent algorithms can be developed using one or more computational experiments. At a broad level, an experiment may be viewed as an execution of a directed acyclic graph of data processing (“DAG”). FIG. 2 illustrates an example of a DAG 200 consistent with embodiments of the present disclosure. In certain embodiments, the DAG 200 may be executed as a set and/or mix of local and/or distributed processes using local and/or remote computing systems.

As illustrated, a data processing layer 202 may receive input data from a variety of data sources and/or providers, including any of the types data sources and/or providers disclosed herein. The input data may be pre-processed and the output of the pre-processing may be stored in an intermediate dataset. In certain embodiments, pre-processing of data may format received input data into a format where one or more computational models may use the data. Pre-processing of data may be associated with a number of configuration and/or runtime parameters involved in the pre-processing. For example, pre-processing parameters may control one or more of data filtering, reformatting, and/or other computational pre-processing operations performed on input data.

The intermediate dataset may be used by one or more computational models to produce output data. In certain embodiments, the computational modules may be associated with one or more one or more parameters in connection with processing intermediate data and/or generating corresponding output data, which in some instances may be referred to as hyper-parameters. Various hyper-parameters consistent with embodiments disclosed herein may comprise, without limitation, evaluation metrics, data and/or files related to the model execution process, and/or the like. Data output by the models may be subsequently used as input data/models for subsequent DAG iterations (e.g., as part of an iterative model optimization loop and/or the like).

During execution of computational models, event data relating to the data processing (e.g., parameters, hyper-parameters, and/or the like), may be stored in data stores 204, which may comprise one or more local and/or remote databases, file systems, and/or cloud repositories. Various event data may be used in connection with, among other things, scheduling, executing, analyzing, visualizing computational models and/or associated data by using and/or interacting with one or more local and/or remote services 206, which may include command line interfaces, libraries, and/or frontend services such as web pages.

Certain experiment steps may be performed by scripts, by manual file operations, and/or by any combination of the same. In some embodiments, a DAG implementation may include some and/or all of the following steps in any suitable order:
Creation, modification, and/or versioning of pre-processing scripts. Versioning of pre-processing scripts may be done manually by, for example, committing associated code to repo and/or automatically.
Source data pre-processing to create data sets for execution. Source data pre-processing may be performed manually and/or automatically running pre-processing scripts. In some embodiments, pre-processing scripts may employ suitable stream execution engines, workflow engines, data pipelines, and/or other suitable methods and/or systems. In some embodiments, source data pre-processing may be managed and/or otherwise be associated with one or more parameters for configuring runtime of the pre-processing scripts.
Storing datasets for future reference. Datasets may be stored manually and/or automatically by streaming and/or saving the datasets and/or references to the datasets to one or more storages.
Creation, modification, and/or versioning of model scripts. Versioning of associated scripts may be done manually by, for example, committing associated code to repo and/or automatically.
Experiment parameterization. Hyper-parameter values, data selection sets, and/or other parameters and/or data used in connection with models may be set manually and/or automatically.
Experiment execution. Experiments may be performed by execution of one or more associated scripts.
Storing the output data, files, and/or logs for future reference. Output data, files, and/or logs may be stored manually and/or automatically. Output data may comprise, without limitation, one or more of model interpretation explanations, method specific output files (e.g., neural network architecture visualization information), and/or training progression metrics.

One or more of the steps detailed above may be repeated iteratively until desired results are achieved. Various embodiments of the disclosed systems and methods may use various data and/or information used and/or generated in connection one or more of the above-detailed steps in connection with interacting with, controlling, and/or otherwise managing one or more experiments associated with the DAG 200. In some embodiments, such interaction, control, and/or management may be performed by a user during experiment execution and/or during the operative use of produced models.

DAG Implementation and Example

In some embodiments, an experiment may be defined in one or more directories in a local and/or remote computing system. In certain embodiments, the local and/or remote systems may use versioning control (e.g., git, svn, etc.) to track and/or otherwise manage various file versions. Various aspects of the DAG steps described above may be maintained in one or more sub-directories and/or use specific script names (e.g., preproc folder and/or preproc.py file, output folder, etc.). Scripts may be executed from the folders in a specific file/url path based on an associated execution order. In some embodiments, the system may allow for overriding of default folder structure(s) from configuration file(s) located in a working directory. In further embodiments, the system may allow overriding configuration files from command line parameters.

An example of a DAG execution via command line interface is provided below:

dist/kogu.exe run./examples/tensorflow.py-version 12.8.3-remote kogu.io-gpus 15-paramepochs=100-param learning_rate=0.001

In the above example, the command runs an executable that executes a script named tensorflow.py version 12.8.3 on a remote server available via domain kogu.io, limiting the run to 15 gpus and setting training parameters to 100 epochs with a learning rate 0.001. In some embodiments, result(s) of this execution may be observed via a web user interface (“UI”), through one or more suitable APIs, via console, and/or via any other suitable user interface. In certain embodiments, the output may be a log of metrics that may be automatically parsed for visualization and/or storage. It will be appreciated that alternative ways of execution may also be employed including, for example, via libraries, user interfaces and/or APIs accessible on premise and/or via cloud services (e.g., cloud micro-services), and/or any other suitable method.

Event Versioning and Storage

A variety of information and/or or data used and/or generated in connection with the DAG 200 may be stored and/or otherwise maintained in connection with the disclosed embodiments (e.g., stored in data stores 202 and/or the like). In certain embodiments, information and/or data may be stored for each executed experiment. In some embodiments, such information and/or data may include, without limitation, one or more of:
Directory tags. When a code versioning repository is found in working directory(ies), the system may record which tag the directory is on and/or whether the associated code has been committed to a repository.
Code diffs. The system may store code diffs associated with pre-processing and execution scripts, providing comparison/reference to prior versions in a code versioning system.
File logs. The files in subfolders (e.g., logs, input data, output files, etc) may be logged for standard file attributes such as, for example, name, creation-time, and/or size. The files may be uploaded to a remote server.
Comments and metadata. The system may store user and/or automated script defined comments, which can reference execution and/or data files (and/or sources). The system may fetch and/or store metadata for the referenced files.
Parameters. The system may store various pre-processing and/or hyperparameters and/or associated values used for execution of scripts (e.g., hyperparameters of model scripts and/or the like).
Environment variables. The system may store various values of environment variables that, in some embodiments, may comprise a predefined set of environment variables.
Versioning information. The system may store version information of executables (e.g., known executables) used to execute scripts.

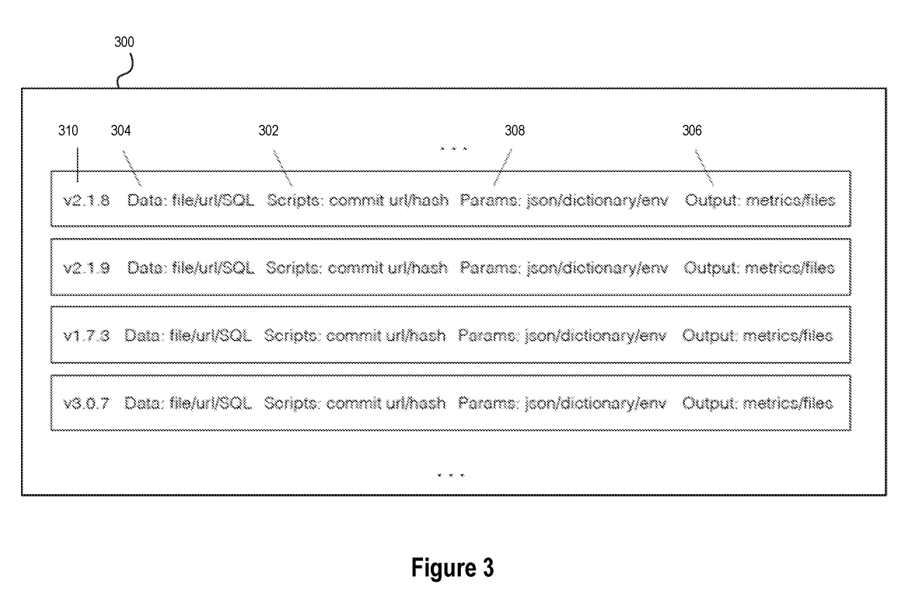

FIG. 3 illustrates an example of various information 300 stored in connection execution event versioning consistent with embodiments of the present disclosure. In some embodiments, version information relating to runs (i.e., experiment executions) of various experiments may be stored. In some embodiments, versioning consistent with various aspects of the disclosed embodiments may be implemented by one or more of:
Committing scripts and files to git, svn, and/or other code versioning repositories and/or file storage systems and/or storing references 302 to the commits and/or files in an events storage.
Making copies of script, data 304, and/or output files and/or metrics 306 to file storages in on-premise and/or cloud infrastructure.
Versioning of data 304 may be implemented using data versioning systems and/or by storing references to used data (e.g. SQL queries and timestamps of query execution).
Keeping track of parameters 308 used in scripts during runtime in a storage relating the parameters to scripts, data and output, timestamps, experiment hashes and/or other metadata stored about the events in a DAG.

In certain embodiments, versioning, which may be reflected in associated version numbering 310 and/or other version identification, may be implemented as a branching system. For example, as illustrated, versioning may be implemented by storing branch information in the execution run in a format: <main branch name>/<sub-branches>/ . . . /<hash>, although other suitable versioning conventions and/or formats may also be used. In certain embodiments, a versioning branch tree may be illustrated visually via a dashboard interface, described in more detail below, showing the various relations between version branches.

Consistent with various disclosed embodiments, a versioned experiment model may be deployed to one or more computing and/or control systems associated with the disclosed systems and methods. In some embodiments, the deployment may be implemented by wrapping the model into a microservice and/or making it available via an API. Further embodiments may employ transferring the code to a control manually and/or automatically using specific software packages interfacing with the computing and/or control system. In certain embodiments, versioned models may be deployed to software simulators. In yet further embodiments, deployment may be conducted manually by transforming scripts to alternative implementations and using references to connect a version consistent with embodiments disclosed herein to a deployed version.

Data Science Intelligence: Algorithms and Metrics Dashboards

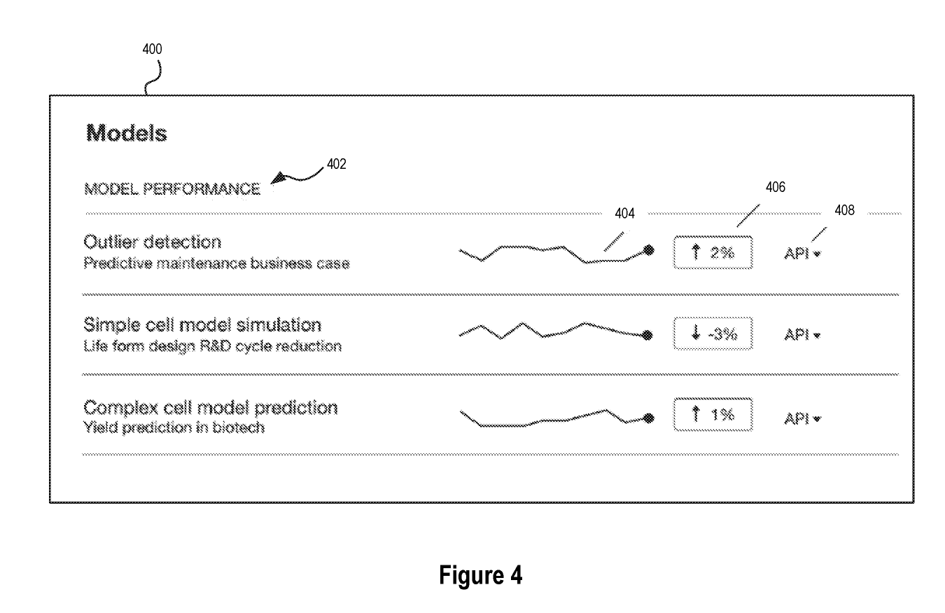

FIG. 4 illustrates an example of a dashboard interface 400 for interacting with predictive models consistent with embodiments of the present disclosure. As illustrated, the dashboard 400 may include a list of models 402 that may show various associated model states and/or status such as, for example, training, online, execution, optimization, maintenance, archival, and/or other states. In certain embodiments, listed models 402 may be associated with local and/or distributed data processing systems using data associated with local and/or remote data stores.

In some embodiments, the dashboard interface 400 may provide an indication of one or more performance metrics 404 associated with the various models. For example, as illustrated, one or more stacked time-series graphs may be displayed providing an indication of associated model performance. In some embodiments, the indication(s) of the one or more performance metrics 404 may be updated in near and/or real time as associated scripts are executed. In further embodiments, the dashboard interface 400 may provide an indication of one or more changes of one or more performance metrics 406 quantified over a time period. For example, a change in an area under the curve (“AUC”) metric may be displayed.

Metrics 404, 406 associated with a variety of types of algorithms, which may include supervised learning algorithms, unsupervised learning algorithms, and/or semi-supervised learning algorithms. Algorithms that may be used in connection with the disclosed embodiments may comprise, without limitation, one or more of regression algorithms, such as ordinary least squares regression, linear regression, stepwise regression, multivariate adaptive regression splines, locally-estimated scatterplot smoothing, and/or other similar algorithms. Further examples of algorithms may include one or more of instance-based learning models such as k-nearest neighbor, learning vector quantization, self-organizing map, locally-weighted learning, and/or other similar methods. Other examples of algorithms may comprise regularization algorithms such as ridge regression, least absolute shrinkage and selection operator, elastic net, least-angle regression, and/or other similar algorithms.

Further examples of algorithms that may be used in connection with various disclosed embodiments include one or more of decision tree methods and/or algorithms such as classification and regression tree, iterative dichotomiser 3, C4.5, C5.0, chi-squared automatic interaction detection, decision stump, M5, conditional decision trees, and/or other similar algorithms. A variety of methods and models may be used in connection with various disclosed embodiments including, without limitation, one or more Bayesian methods such as naive Bayes, Gaussian naive Bayes, multinomial naive bayes, averaged one-dependence estimators, Bayesian belief network, Bayesian network, and/or other similar methods. Certain algorithms that may be used in connection with the disclosed embodiments also include clustering methods, models, and/or algorithms such as k-means, k-medians, expectation maximization, hierarchical clustering, and/or other similar models. Further examples of algorithms that may be used in connection with the disclosed embodiments may include association rule learning algorithms such as apriori algorithm, éclat algorithm, and/or other similar algorithms.

In some embodiments, the algorithms may comprise artificial neural network algorithms such as perceptron, back-propagation, Hopfield network, Kohonen network, support vector machine, radial basis function network, deep feed forward, and/or the like. Some embodiments may further be used in connection with deep learning methods such as deep Boltzmann machine, deep belief networks, convolutional neural networks, stacked auto-encoders, variational auto-encoders, denoising auto-encoders, sparse auto-encodres, markov chains, restricted Boltzmann Machines, deconvolutional networks, deep convolutional inverse graphics networks, generative adversarial networks, liquid state machines, extreme learning machines, echo state networks, deep residual networks, and/or other architectures of artificial neural networks.

Further examples of algorithms that may be used in connection with the disclosed systems and methods may include dimensionality reduction algorithms, such as principal component analysis, principal component regression, partial least squares regression, Sammon mapping, multidimensional scaling, projection pursuit, linear discriminant analysis, mixture discriminant analysis, quadratic discriminant analysis, flexible discriminant analysis, and/or other similar methods. In further embodiments, ensemble methods composed of multiple other models may be used, such as boosting, bootstrapped aggregation (bagging), AdaBoost, stacked generalization (blending), gradient boosting machines, gradient boosted regression trees, random forests, and/or other similar methods, models, and/or algorithms. Yet further examples of algorithms that may be used include feature selection algorithms and/or other specific algorithms such as evolutionary algorithms, genetic algorithms, swarm intelligence algorithms, ant colony optimization algorithms, computer vision algorithms, natural language processing algorithms, naive discrimination learning algorithms, statistical machine translation methods, recommender systems, reinforcement learning, graphical models and/or other models used in machine learning, data mining, data science, and/or other related fields. For example, the models may be numerical analysis methods and algorithms, such as computational fluid dynamics simulations, finite element analysis simulations, and/or other similar computer simulations.

It will be appreciated that a variety of types of algorithms, models, methods, and/or experiments may be used in connection with aspects of the disclosed embodiments, and that any suitable type of algorithms, models, methods, and/or experiments may be used in connection with the systems and methods disclosed herein.

For algorithm accuracy evaluation algorithms and/or model performance, a variety of different methods may be used, such as, for example, error metrics for regression problems like mean absolute error, weighted mean absolute error, root mean squared error, root mean squared logarithmic error, and/or other similar metrics. Further examples of metrics that may be used in connection with the disclosed embodiments include error metrics for classification problems, such as logarithmic loss, mean consequential error, mean average precision, multi class log loss, Hamming loss, mean utility, Matthews correlation coefficient, and/or other similar methods. Further metrics that may be employed in connection with the disclosed embodiments include one or more of metrics generated based on probability distribution functions such as continuous ranked probability score, and/or other similar metrics. In some embodiments, metrics like AUC, Gini, average among top P, average precision (column-wise), mean average precision (row-wise), averageprecision K (row-wise), and/or other similar metrics may be used. For some models, methods, and/or algorithms, other metrics such as normalized discounted cumulative gain, mean average precision, mean F score, Levenshtein distance, average precision, absolute error, and/or other similar or distinct metrics may be used.

It will be appreciated that a variety of accuracy evaluation and/or performance metrics may be used in connection with aspects of the disclosed embodiments, and that any suitable type of measure of accuracy and/or performance metric may be used in connection with the systems and methods disclosed herein.

Various models used in connection with the disclosed embodiments may be accessible via a programmable API. In some embodiments, the API may be accessible via a link 408 included in the dashboard interface 400.

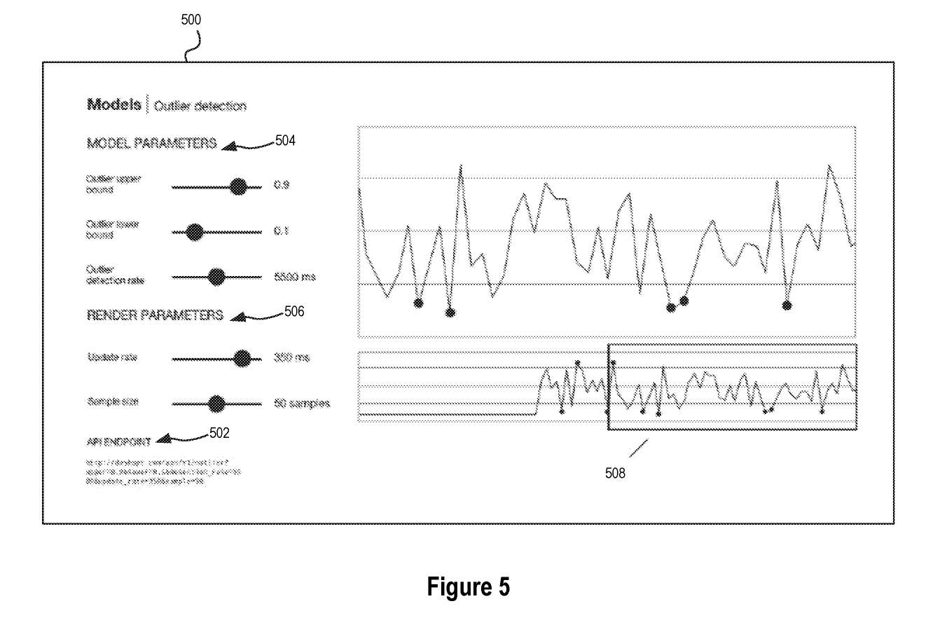

FIG. 5 illustrates an example of a dashboard interface 500 for outlier detection consistent with embodiments of the present disclosure. In certain embodiments, the dashboard interface 500 may include an API endpoint description 502. In some embodiments, API calls may form a network of models for which each network node may be associated with API results listed in a model list as a model whose performance is tracked (e.g., in connection with the dashboard interface 400 of FIG. 4 and/or the like). Performance data may be accessed in a number of suitable ways, including via Web Socket, REST API call, HIVE database, key-value store, structured logs, unstructured text, and/or via other data streaming and/or data storage solutions. In certain embodiments, the dashboard interface 500 may be extended with controls for managing a large number of models, and may include controls that may comprise search boxes, filtering links, ordering links, paginations, hierarchical trees, collapsible sub-lists, and/or other interactive controls used for interacting with numeric values, tables, and/or visualizations.

Real Time Model Changes

The dashboard interface 500 for outlier detection provides an interface and/or visualization of execution results of an anomaly detection algorithm running on a real-time time-series data stream. As illustrated, the associated model may have one or more internal hyper-parameters 504 that may be adjusted to change the output of the model. The hyper-parameters 504 may include, for example, thresholds of outliers detected by the model and/or the processing time of the model to detect outliers. Additional model parameters 506 may be associated with rendering and/or visualizing the results of the models such as, for example, an update rate and/or a sample rate. In some embodiments, parameters 504, 506 may be changed either manually by a user via the interface 500 and/or automatically by associated algorithms (e.g., neural network algorithms, genetic algorithms, and/or the like). In further embodiments, a user may focus on a specific time period of a data stream by defining a time window 508 using the interface 500 and/or programmatically via function call parameters.

In certain embodiments, when model parameters 504, 506 have been changed, an API endpoint 502 may be generated with the values of the model present as GET parameters, POST parameters, and/or the like. An API request snipet may be used as input for other models for example by adding an identifier to the API snipet and providing it as input parameter for the API call of another model. Examples of such APIs may be endpoints to models produced using frameworks and services such as TensorFlow, Azure ML, Amazon ML, Google ML, H2O, Caffe, Theano, Keras, MLib, scikit-learn, PyTorch, and/or other technologies based on Java, Scala, Python, Lua, C++, Julia, C#, JavaScript, R, and/or other programming languages.

Numeric Simulations and Optimizing Models

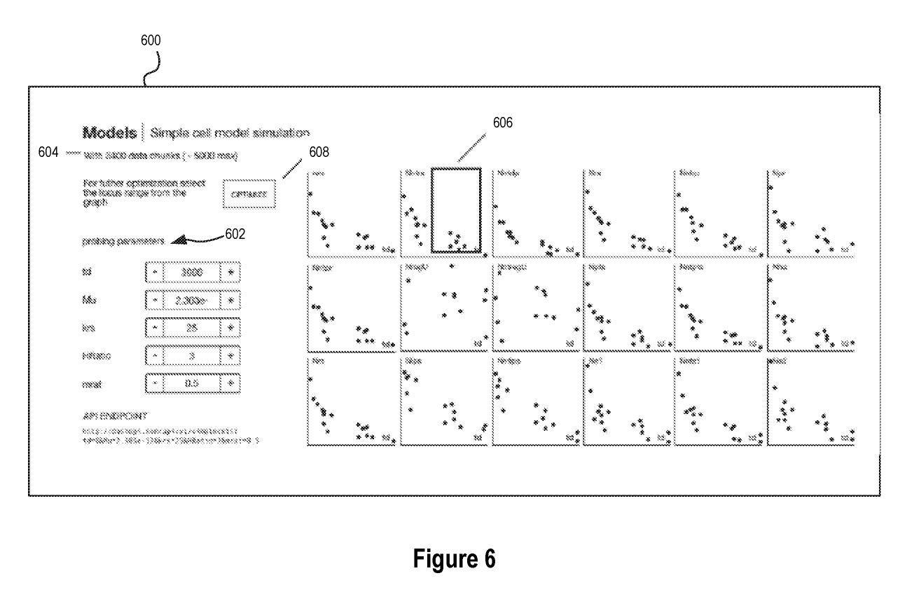

In some embodiments, models may be parallelized and/or run in parallel. FIG. 6 illustrates an example of an interface 600 for numeric simulation visualization consistent with embodiments of the present disclosure. The interface 600 illustrates an example of models based on a system of linear equations running in parallel. Consistent with various disclosed embodiments, the results from parallel execution of models and/or from continuous output of a single model may be presented to a user via the interface 600 user using visualizations (e.g., as a scatterplot, although other suitable types of visualizations are also contemplated that may, in certain instances, depend on an associated type of model).

In some embodiments, new data points may be visualized in the interface 600 as they are received from associated computational processes. For example, new points may be displayed in a scatterplot as they are received from computational processes. In some embodiments, simulations and/or parallelized runs of models may be configured by adjusting one or more associated parameters 602 that, in certain embodiments, may produce output constrained by one or more limits 604. The visualizations may be used to aid a user in managing and/or guiding simulations and/or parallel execution of models into a particular area of parameters, for example, by a selection of values 606. Such selections may be forwarded to an execution engine implementing an optimization method 608 and/or plain execution. Examples of such optimization methods include, without limitation, grid search, random search, Bayesian optimization, and/or other similar methods, which may be run iteratively.

Combining Model Output and Actual Data

In connection with various disclosed embodiments, models may be used to predict, among other things, a variety of real world phenomenon and/or be used in a variety of industry applications such as the manufacturing of electronics and/or biotechnological products like pharmaceutics. Other industries where models may be applied include, without limitation, the automotive industry (for example, in connection with route optimization), transportation and logistics, ridesharing, synthetic biology, organism engineering, investment finance, retail finance, energy intelligence, internal intelligence, market intelligence, non-profit initiatives, personal health, agriculture, enterprise sales, enterprise security and fraud detection, enterprise customer support, advertisements, enterprise legal, and/or any other industry applying predictive methods.

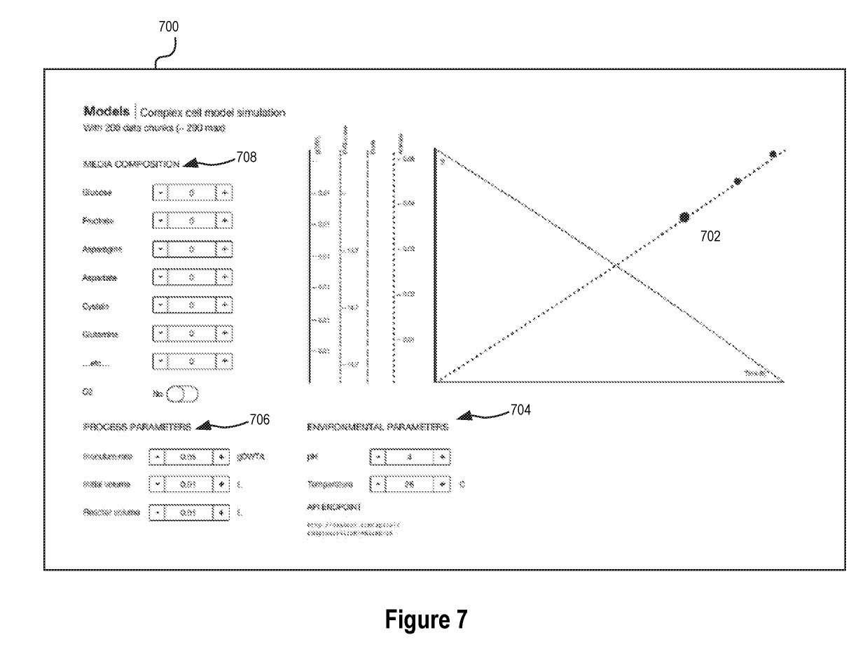

Consistent with embodiments disclosed herein, predicted model outputs may be shown in reference to actual data in connection with a dashboard interface. FIG. 7 illustrates an example of an interface 700 for interacting with a predictive model consistent with embodiments of the present disclosure. Specifically, the interface 700 of FIG. 7 shows predicted model output next to actual data 702. In certain embodiments, models may be managed and/or otherwise configured based on controls for editing numeric values, categorical values, value ranges, and/or other types of parameters relating to the environment 704 and/or processes 706.

In some embodiments, the internals of a model specific to an application (e.g., media composition 708) may also be configured and/or otherwise managed to produce models fit for the purpose (e.g., example media composition in connection with fermentation processes). In some embodiments, the values and configuration of the models may be configured manually and/or automatically (e.g., by other systems such as control systems, industrial automation devices, industrial gateways, industrial data and analytics platforms, and/or the like). Visualizations may be presented to the user in a variety of interfaces including, for example using devices connected to computer systems. For example, data and predictions may be presented in combination in connection with a production line performance prediction to reduce manufacturing failures. A time-series of actual quality and safety issues detected may be shown next to predicted quality and safety issues along with statistics and metrics on the performance of the model. By being able to reconfigure the model with automated or semi-automated deployment, the value of the model can be increased in cases when there are changes in the environment, object, and/or processes that the model tries to predict.

Feature Identification

As models are trained and/or operated, residual data streams may be produced by the models. These data streams may be input to further models that may be also visualized via a dashboard interface consistent with various disclosed embodiments. For example, feature engineering results and variable ranking results from operational models may be used as inputs to subsequent models.

In certain implementations, the number of identified data features can grow relatively large. Accordingly, various embodiments may provide for user interface facilities that may utilize methods for efficiently interacting with relatively long lists and/or relatively large numbers of numeric and/or categorical values. Examples of such methods include, without limitation, filtering, search, hierarchical user interfaces, collapsible and extensible elements, and/or the like.

User dashboard interfaces consistent with embodiments disclosed herein may present ways to highlight features of interest in a model training and/or production environment. Some ways of highlighting include, without limitation, ordered lists of values, time-series graphs showing the importance change of a feature in time, and/or the like. In some embodiments, as may be the case when a relatively large number of time-series graphs are used, some graphs may be shown initially and the user may be able to toggle visibility of a feature graph using appropriate user interface controls.

Example: Manufacturing Applications

Embodiments of the disclosed systems and methods may be used in connection with an on-premise analytical model validation environment in electronics manufacturing applications. For example, models may be employed for monitoring and predicting item statuses and processing times over given time windows, failure rates in production, distribution of work between resources in a given time window, activity duration by operations for a given time window, cycle times for operations and production batches, and/or the like. Such models may be used on-premise or via cloud accessible over VPN and the output of the models may be connected to machinery operating in a production floor for guiding the operations of such machinery.

Example: Biotechnology Applications

Process Analytical Technology (“PAT”) and Quality by Design (“QbD”) are components of biotechnology production as well as R&D processes. PAT and QbD applications for process design and control may be solved by measuring and understanding the variation that exists in historical data using statistical techniques. Using predictive models, PAT and QbD can be improved by predicting the outcome of these activities in advance.

Consistent with embodiments disclosed herein, predictive models may be created and deployed for optimizing various stages from R&D to upstream and downstream bioprocesses. The measurable impact may be increases of yields or lower failure rates, etc. More specifically, the models may be used for optimizing design of experiments in R&D by simulating outcomes of experiments with different parameters. In manufacturing, monitoring process parameters during the course of the bioprocesses may be used as input for the models for controlling the progress of the process. The input for actions in case of deviations from the normality could be automatically decided according to monitored data. For example, optical density in a bioreactor may be used to describe biomass formation, and pH may be used for describing the environmental conditions and cell growth.

Example: Computing Service Applications

Certain embodiments may be used to create and deploy models for optimizing micro-services, such as services deployed in Docker containers and/or JVM runtime and application parameters running on servers in datacenters. For example, in some embodiments, runtime optimization may configure the number of server instances based on performance metrics.

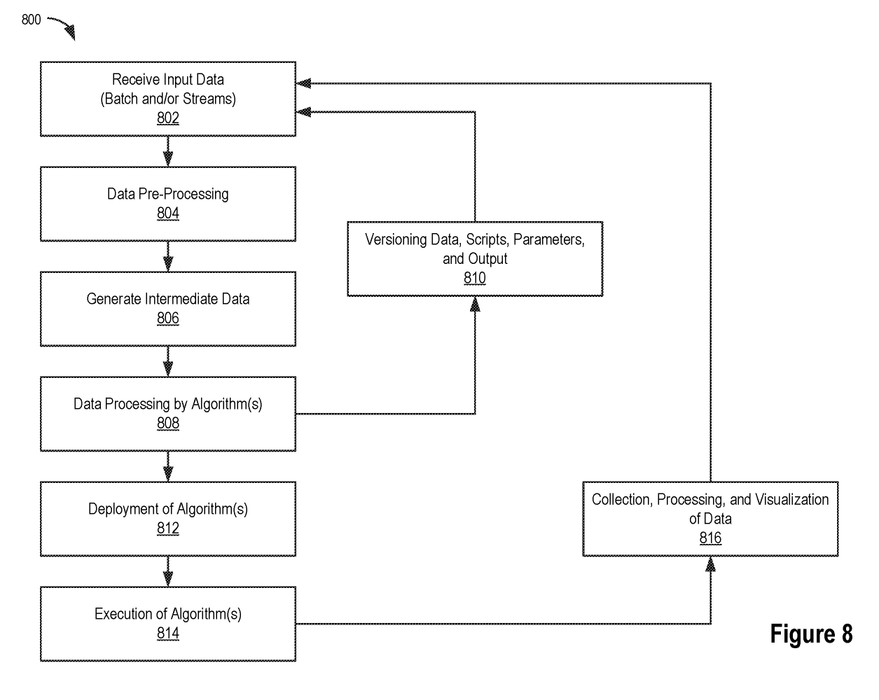

FIG. 8 illustrates a flow chart of an exemplary method 800 of interacting with data consistent with embodiments of the present disclosure. The illustrated method 800 may be implemented in a variety of ways, including using software, firmware, hardware, and/or any combination thereof. In certain embodiments, various aspects of the method 800 and/or its constituent steps may be performed by a computer system configured to interact with various computational experiments, methods, models, and/or algorithms. In certain embodiments, the illustrated method 800 may facilitate management of experiments, methods, models, and/or algorithms consistent with embodiments disclosed herein.

At 802, data may be received from one or more data sources. In some embodiments, data may be received as a batch. In further embodiments, data may be received as part of a data stream. The data may comprise, for example, device and/or system data, planetary, earth and/or geospatial data, manufacturing data, and/or any other suitable type of data in any type of data format.

Received input data may be pre-processed at 804. In some embodiments, pre-processing operations may reformat the data received at 802 into a format where one or more computational models may use the data, and may be performed based on one or more data filtering, reformatting, and/or other pre-processing parameters. Pre-processing the data at 804 may generate intermediate data at 806. In certain embodiments, the method 800 may not include steps relating to the pre-processing 804 and/or generation of intermediate data 806 as illustrated.

At 808, the input data received at 802 and/or the intermediate data generated at 806 may be processed by one or more algorithms and/or associated computational models to generate output data. The output data, along with associated versioning data, scripts, and/or parameters may be stored at 810 and, in some embodiments, may be used in connection with a recursive computation involving steps 802-808 and/or subsets thereof. For example, versioning information including execution events, directory tags, code diffs, file logs, comments and/or metadata, parameters, variables, scripts, and/or the like associated with the data processing 804, 808 may be stored and/or used at 810 in connection with future recursive computations.

Trained algorithms and/or associated computational models may be deployed and/or executed at 812, 814. In some embodiments, users may be able to manage and/or otherwise interact with the algorithms and/or models at 816 consistent with various aspects of the disclosed embodiments. For example, users may be able to interact with various algorithms and/or models based on responses to user requests generated based on versioning information, scripts, parameters, and/or intermediate and/or output data associated with the algorithms and/or computational models (e.g., generated visualizations and/or interactive interfaces and/or the like).

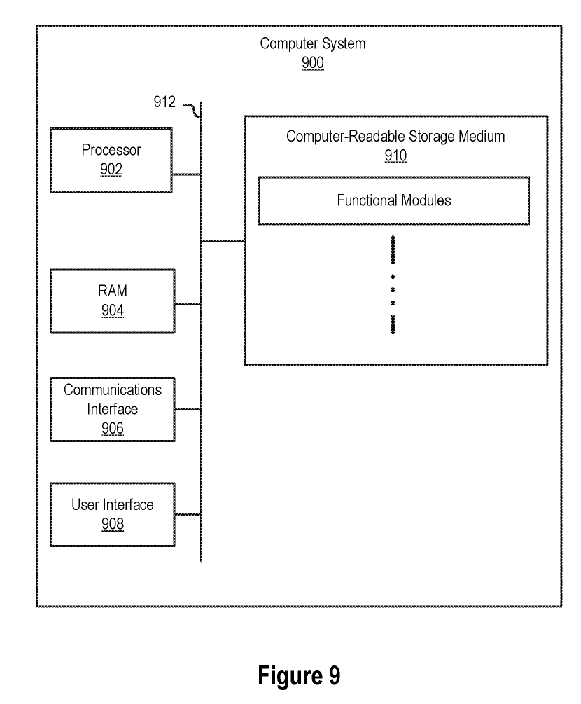

FIG. 9 illustrates an exemplary system 900 that may be used to implement various embodiments of the systems and methods of the present disclosure. In certain embodiments, the computer system 900 may comprise a system for implementing embodiments of the disclosed systems and methods for interacting with, managing, and/or monitoring experiments, algorithms, models, and/or methods. In some embodiments, the computer system 900 may comprise a personal computer system, a laptop computer system, a desktop computer system, a server computer system, a notebook computer system, an augmented reality device, a virtual reality device, a distributed computer system, a smartphone, a tablet computer, and/or any other type of system suitable for implementing the disclosed systems and methods.

As illustrated, the computer system 900 may include, among other things, one or more processors 902, random access memories (“RAM”) 904, communications interfaces 906, user interfaces 908, and/or non-transitory computer-readable storage mediums 910. The processor 902, RAM 904, communications interface 906, user interface 908, and computer-readable storage medium 910 may be communicatively coupled to each other via a data bus 912. In some embodiments, the various components of the computer system 900 may be implemented using hardware, software, firmware, and/or any combination thereof.

The user interface 908 may include any number of devices allowing a user to interact with the computer system 900. For example, user interface 908 may be used to display an interactive interface to a user, including any of the visual interfaces and/or dashboards disclosed herein. The user interface 908 may be a separate interface system communicatively coupled with the computer system 900 or, alternatively, may be an integrated system such as a display interface for a laptop or other similar device. In certain embodiments, the user interface 908 may comprise a touch screen display. The user interface 908 may also include any number of other input devices including, for example, keyboard, trackball, and/or pointer devices.

The communications interface 906 may be any interface capable of communicating with other computer systems and/or other equipment (e.g., remote network equipment) communicatively coupled to computer system 900. For example, the communications interface 906 may allow the computer system 900 to communicate with other computer systems (e.g., computer systems associated with external databases and/or the Internet), allowing for the transfer as well as reception of data from such systems. The communications interface 906 may include, among other things, a modem, an Ethernet card, and/or any other suitable device that enables the computer system 900 to connect to databases and networks, such as LANs, MANs, WANs and the Internet.

The processor 902 may include one or more general purpose processors, application specific processors, programmable microprocessors, microcontrollers, digital signal processors, FPGAs, other customizable or programmable processing devices, and/or any other devices or arrangement of devices that are capable of implementing the systems and methods disclosed herein. The processor 902 may be configured to execute computer-readable instructions stored on the non-transitory computer-readable storage medium 910. The computer-readable storage medium 910 may store other data or information as desired. In some embodiments, the computer-readable instructions may include computer executable functional modules. For example, the computer-readable instructions may include one or more functional modules configured to implement all or part of the functionality of the various embodiments of the systems and methods described above.

It will be appreciated that embodiments of the system and methods described herein can be made independent of the programming language used created the computer-readable instructions and/or any operating system operating on the computer system 900. For example, the computer-readable instructions may be written in any suitable programming language, examples of which include, but are not limited to, C, C++, Visual C++, and/or Visual Basic, Java, Perl, or any other suitable programming language. Further, the computer-readable instructions and/or functional modules may be in the form of a collection of separate programs or modules, and/or a program module within a larger program or a portion of a program module. The processing of data by computer system 900 may be in response to user commands, results of previous processing, or a request made by another processing machine. It will be appreciated that computer system 900 may utilize any suitable operating system including, for example, Unix, DOS, Android, Symbian, Windows, iOS, OSX, Linux, and/or the like.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic tape, a Bernoulli drive, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims.

What is claimed is:

1. A method of processing data performed on a system comprising a processor and a non-transitory computer-readable storage medium storing instructions that, when executed, cause the system to perform the method, the method comprising:
receiving data from at least one data source;
processing at least a first portion of the received data using a computational model based, at least in part, on a first set of one or more parameters, to generate first output data;
storing first computational model version information comprising a first set of execution events associated with generating the first output data using the computational model and the first set of one or more parameters;
generating a second set of one or more parameters;
processing at least a second portion of the received data using the computational model based, at least in part, on the second set of one or more parameters, to generate second output data;
storing second computational model version information comprising a second set of execution events associated with generating the second output data using the computational model and the second set of one or more parameters;
receiving a request from a requesting system for information associated with the computational model;
generating a response based, at least in part, on the first computational model version information and the second computational model version information; and
transmitting the response to the requesting system.

2. The method of claim 1, wherein receiving the data comprises receiving the data as batch data.

3. The method of claim 1, wherein receiving the data comprises receiving the data as a data stream.

4. The method of claim 1, wherein the at least one data source comprises at least one of a device information data source, a planetary information data source, and a manufacturing information data source.

5. The method of claim 1, wherein the at least a first portion of the received data and the at least a second portion of the received data are the same.

6. The method of claim 1, wherein the at least a first portion of the received data and the at least a second portion of the received data differ at least in part.

7. The method of claim 1, wherein processing the at least a first portion of the received data using the computational model comprises:
pre-processing the at least a first portion of the received data to generate first intermediate data based, at least in part, on a third set of one or more parameters,
wherein the first computational model version information further comprises a third set of execution events associated with generating the first intermediate data and the third set of one or more parameters.

8. The method of claim 7, wherein processing the at least a first portion of the received data using the computational model comprises processing the first intermediate data using the computational model.

9. The method of claim 7, wherein processing the at least a second portion of the received data using the computational model comprises:
pre-processing the at least a second portion of the received data to generate second intermediate data based, at least in part, on the third set of one or more parameters,
wherein the second computational model version information further comprises a fourth set of execution events associated with generating the second intermediate data and the third set of one or more parameters.

10. The method of claim 9, wherein processing the at least a second portion of the received data using the computational model comprises processing the second intermediate data using the computational model.

11. The method of claim 1, wherein the first computational model version information comprises a unique version identifier associated with the first computational model version information.

12. The method of claim 11, wherein the version identifier comprises a branching version identifier.

13. The method of claim 1, wherein the first computational model version information comprises at least one script associated with the computational model.

14. The method of claim 1, wherein the first computational model version information comprises an indication of a location of at least one script associated with the computational model.

15. The method of claim 1, wherein processing the at least a second portion of the received data based, at least in part, on the second set of one or more parameters using the computational model to generate the second output data further comprises:
updating the computational model based, at least in part, on the second set of one or more parameters; and
processing the at least a second portion of the received data based, at least in part, on the updated computational model to generate the second output data.

16. The method of claim 15, wherein the second computational model version information comprises an indication of a difference between at least one updated script associated with the updated computational model used to generate the second output data and at least one script associated with the computational model used to generate the first output data.

17. The method of claim 15, wherein the second computational model version information comprises an indication of a difference between the first set of one or more parameters and the second set of one or more parameters.

18. The method of claim 1, wherein the first set of one or more parameters comprises one or more of a bounding parameter, a detection rate parameter, an update rate parameter, a sample size parameter, a data window parameter, a probing parameter, a process parameter, and an environmental parameter.

19. The method of claim 1, wherein the first computational model version information comprises information associated with the at least a first portion of the received data.

20. The method of claim 1, wherein the first computational model version information comprises information associated with the first output data.

21. The method of claim 1, wherein generating the second set of one or more parameters is further based on at least one user specified parameter.

22. The method of claim 1, wherein generating the second set of one or more parameters is further based on at least one system specified parameter.

23. The method of claim 1, wherein processing the at least a second portion of the received data based, at least in part, on the second set of one or more parameters using the computational model to generate the second output data further comprises processing at least a portion of the first output data to generate the second output data.

24. The method of claim 1, wherein generating the second set of one or more parameters is based, at least in part, on the first output data.

25. The method of claim 1, wherein generating the response is further based, at least in part, on the first output data and the second output data.
